(19) United States
(12) Patent Application Publication
(10) Pub. No.: US 2021/0352919 A1
(43) Pub. Date: Nov. 18, 2021

(54) System and Method of Making a Messaging Food Product

(71) Applicant: La Theia Chanel Black, Rancho Cucamonga, CA (US)

(72) Inventor: La Theia Chanel Black, Rancho Cucamonga, CA (US)

(21) Appl. No.: 17/318,903

(22) Filed: May 12, 2021

Related U.S. Application Data
(60) Provisional application No. 63/023,704, filed on May 12, 2020.

(51) Int. Cl. A21D 13/47; B23K 26/362

(52) U.S. Cl. CPC A21D 13/47; B23K 26/362

(57) ABSTRACT

A system and method making a messaging food product provides positive message for a consumer eating the food product. The system includes an oven and a flat spoon. The flat spoon includes a first half portion and a second half portion, both of which share a first face and a second face. At least one spoon message is inscribed onto the first face and includes a primary message, positioned within the first half portion. The method begins by baking a food product within the oven, then is removed from the oven. The second half portion is inserted into the food product within a specified time period. The first face is oriented away from an external surface of the food product, and the second face towards the external surface of the food product. The primary message is therefore easily seen by the consumer of the food product.

The current application claims a priority to the U.S. provisional patent application Ser. No. 63/023,704 filed on May 12, 2020.

### FIELD OF THE INVENTION

The present invention generally relates to customized food products. More specifically, the present invention makes a messaging food product.

### BACKGROUND OF THE INVENTION

Muffins are widely popular confections that are sold everywhere from bakeries to grocery stores and even online for delivery. Muffins are often decorated with various ornamental accessories, such as edible decorations or packaging, but few provide an inspirational message on a utensil inserted into the muffin.

An objective of the present invention is to combine a unique set of muffins and other baked goods with inspirational messages laser printed onto a flat spoon that can be used to easily eat the muffins and baked goods. The flat spoon is designed to provide a legible inspirational message. The spoon is also inserted into the muffin or baked good right after baking the muffin or baked good as to not damage the spoon or the message imprinted on the flat spoon.

### BRIEF DESCRIPTION OF THE DRAWINGS

FIG. 1 is a diagram for the system of the present invention.

FIG. 2 is a schematic view for a first face of for a flat spoon of the present invention.

FIG. 3 is a schematic view for a second face of for the flat spoon of the present invention.

FIG. 4 is a flowchart illustrating the overall process for a method of the present invention.

FIG. 5 is a flowchart illustrating the subprocess of printing at least one spoon message of the present invention.

FIG. 6 is a flowchart illustrating the subprocess of printing at least one decoration of the present invention.

### DETAIL DESCRIPTIONS OF THE INVENTION

All illustrations of the drawings are for the purpose of describing selected versions of the present invention and are not intended to limit the scope of the present invention.

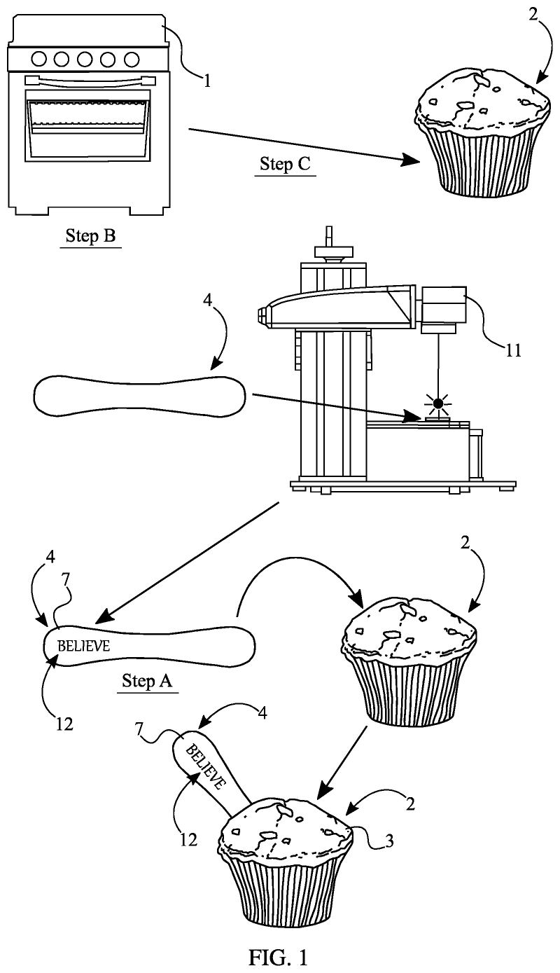

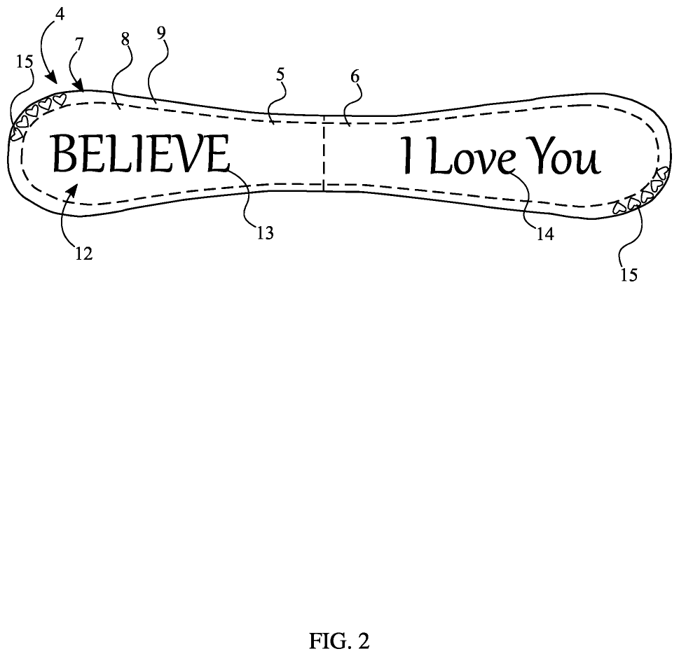

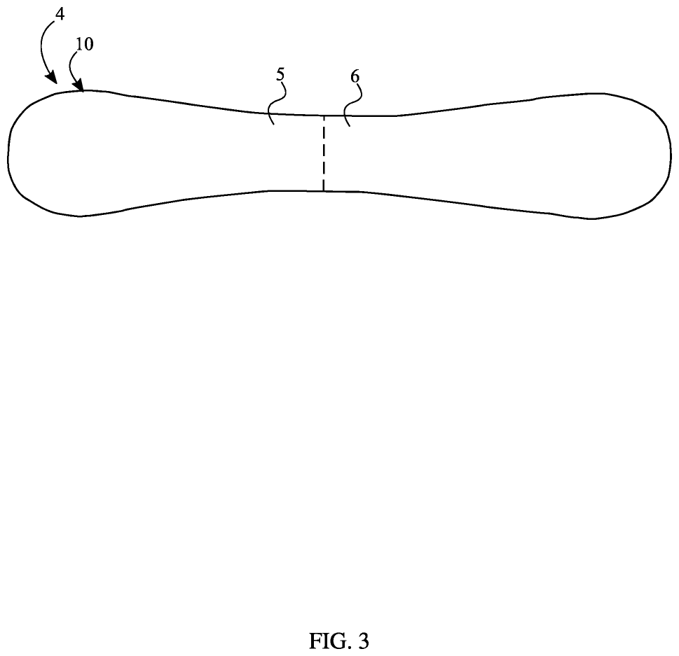

The present invention is a system and method of making a messaging food product. The present invention provides an uplifting message with a satisfying food product, preferably a baked good. More specifically, the uplifting message is reinforced with a rewarding treat. Thus, the physical system used to implement the method for the present invention includes an oven 1 and a flat spoon 4, wherein the flat spoon 4 includes a first half portion 5 and a second half portion 6 (Step A), seen in FIG. 1, FIG. 2, and FIG. 3. Furthermore, the flat spoon 4 is preferably made with a biodegradable, food-safe materials such as wood. The first half portion 5 and the second half portion 6 are positioned adjacent to each other. The first half portion 5 may be grasped by a user to maneuver the second half portion 6 in order to be used as an eating utensil. In the preferred embodiment of the present invention, a first end of the flat spoon 4 is positioned opposite a second end of the flat spoon 4. The first half portion 5 is positioned adjacent with the first end. Likewise, the second half portion 6 is positioned adjacent with the second end. The flat spoon 4 preferably tapers from the first end towards the second half portion 6 and preferably tapers from the second end towards the first half portion 5. The first half portion 5 is also the displayable portion of the flat spoon 4. Moreover, the first half portion 5 and the second half portion 6 share a first face 7 and a second face 10, wherein the first face 7 and the second face 10 are positioned opposite to each other about the flat spoon 4. The first face 7 is directly visible to the surroundings, and the second face 10 is oriented towards the food product 2. More specifically, at least one spoon message 12 is inscribed onto the first face 7. The at least one spoon message 12 is an inspiring message. The at least one spoon message 12 also includes a primary message 13, wherein the primary message 13 is positioned within the first half portion 5. The primary message 13 is predetermined and is preferably “Believe.” It is understood that various embodiments of the present invention may feature a primary message 13 of various single-worded messages.

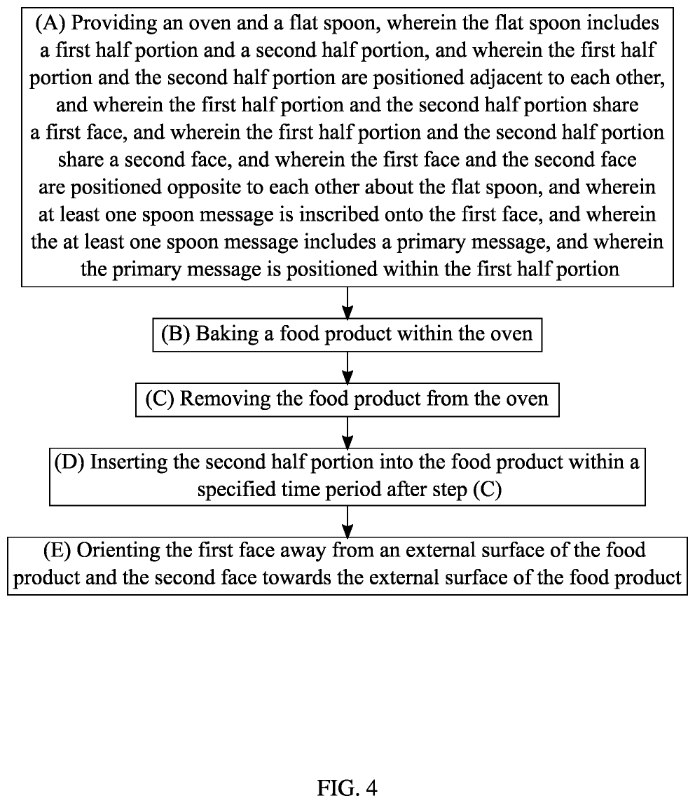

The overall process for the method of the present invention includes the following steps that are implemented with the oven 1 and the flat spoon 4. The method begins by baking a food product 2 within the oven 1 (Step B), seen in FIG. 4. The food product 2 can be, but is not limited to, a muffin, a cookie, a pie, a casserole, or a pastry. Moreover, the food product 2 preferably provides a structure that is able to uphold the flat spoon 4. Upon completion of baking the food product 2, the food product 2 is then removed from the oven 1 (Step C). As the food product 2 requires time to cool down before consumption, the second half portion 6 is inserted into the food product 2 within a specified time period after Step C (Step D) while the food product 2 is more pliable. The specified time period is preferably 5 minutes so that the structural integrity and the outward appearance of the food product 2 is preserved with the insertion of the flat spoon 4. In order for the primary message 13 to be easily visible, the first face 7 is oriented away from an external surface 3 of the food product 2, and the second face 10 is oriented towards the external surface 3 of the food product 2 (Step E). Thus, in a typical embodiment of the present invention, the first face 7 would be oriented at an obtuse angle with the external surface 3 of the food product 2, while the second face 10 would be oriented at an acute angle with the external surface 3 of the food product 2.

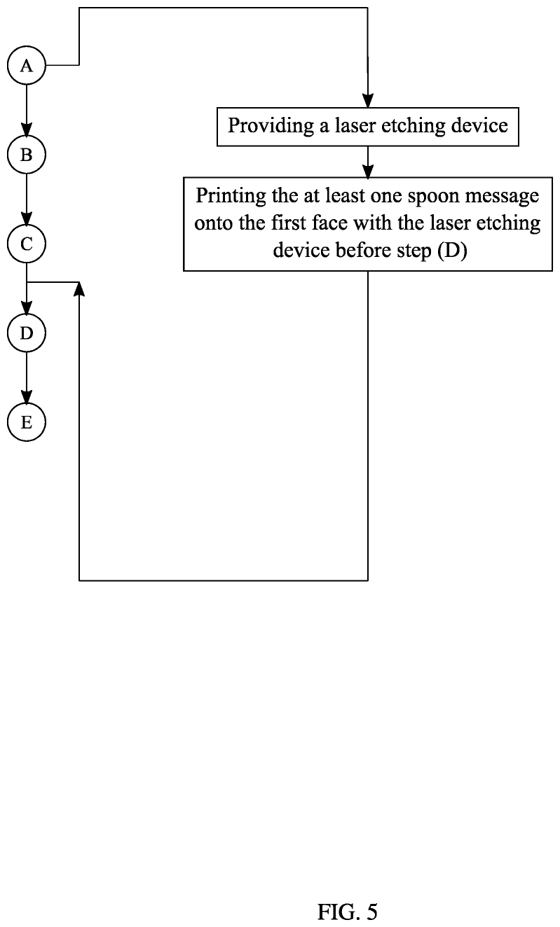

The at least one spoon message 12 is imprinted into the flat spoon 4 as a laser etching device 11 is further provided for the present invention, seen in FIG. 1 and FIG. 5. The laser etching device 11 preferably utilizes non-toxic edible laser ink. The laser etching device 11 provides a permanent inscription onto the flat spoon 4 so that any oils or heat from the food product 2 are not able to erase or reduce the visibility of the at least one spoon message 12. The laser etching device 11 also provides accurate and detailed inscriptions for the flat spoon 4 with the limited space for the first face 7 of the flat spoon 4. The at least one spoon message 12 is printed onto the first face 7 with the laser etching device 11 before Step D so that the at least one spoon message 12 is imprinted into the flat spoon 4 before being situated into the food product 2. The at least one spoon message 12 is preferably inscribed in a green color, however, it is understood that various embodiments of the present invention may feature a variety of colors.

The present invention is further customizable as the at least one spoon message 12 also includes a secondary message 14, seen in FIG. 2. The secondary message 14 is preferably a complete statement or question that is directed to a user eating the food product 2. The secondary message 14 can be, but is not limited to, “I love you,” “Will you marry me,” or “Have a great day!”. The secondary message 14 is positioned within the second half portion 6 so that the secondary message 14 serves as a surprise and a private message for the user eating the food product 2. More specifically, the secondary message 14 is either predetermined content or customized content, wherein the predetermined content is of a selection of content, and wherein the customized content is a specific request.

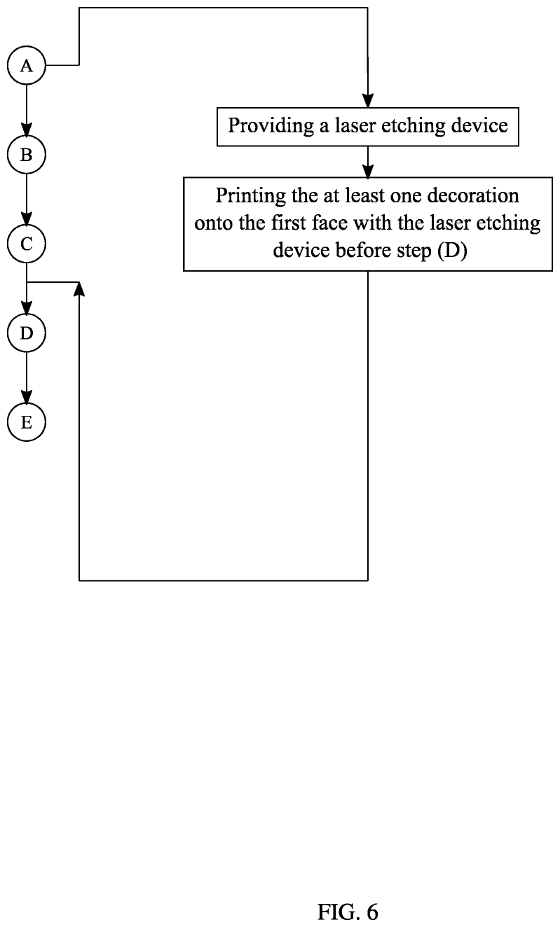

In order to enhance the aesthetic of the flat spoon 4 with the at least one spoon message 12 and reinforce the at least one spoon message 12, at least one decoration 15 is inscribed onto the first face 7, seen in FIG. 6. The at least one decoration 15 may include, but is not limited to, hearts, border and corner designs, stars, and a variety of other symbols. The at least one decoration 15 is positioned peripheral to the at least one spoon message 12 as to not distract from the at least one spoon message 12. Similar with the primary message 13 and the secondary message 14, the at least one decoration 15 is printed onto the first face 7 with the laser etching device 11 before Step D so that the at least one decoration 15 is also easily visible.

In order to provide a legible message, the first face 7 also includes a central section 8 and a margin section 9. The central section 8 provides ample space for both the primary message 13 and the secondary message 14. The margin section 9 provides ample space between the central section 8 and the edges of the flat spoon 4. Moreover, the margin section 9 provides space for the at least one decoration 15. More specifically, the margin section 9 is positioned around the central section 8, and the at least one spoon message 12 is positioned within the central section 8.

Although the invention has been explained in relation to its preferred embodiment, it is to be understood that many other possible modifications and variations can be made without departing from the spirit and scope of the invention as hereinafter claimed.

What is claimed is:

1. A method of making a messaging food product, the method comprises the steps of:
(A) providing an oven and a flat spoon, wherein the flat spoon includes a first half portion and a second half portion, and wherein the first half portion and the second half portion are positioned adjacent to each other, and wherein the first half portion and the second half portion share a first face, and wherein the first half portion and the second half portion share a second face, and wherein the first face and the second face are positioned opposite to each other about the flat spoon, and wherein at least one spoon message is inscribed onto the first face, and wherein the at least one spoon message includes a primary message, and wherein the primary message is positioned within the first half portion;
(B) baking a food product within the oven;
(C) removing the food product from the oven;
(D) inserting the second half portion into the food product within a specified time period after step (C); and,
(E) orienting the first face away from an external surface of the food product and the second face towards the external surface of the food product.

2. The method of making a messaging food product, the method as claimed in claim 1 comprises the steps of:
providing a laser etching device; and,
printing the at least one spoon message onto the first face with the laser etching device before step (D).

3. The method of making a messaging food product, the method as claimed in claim 1, wherein the at least one spoon message is inscribed in a green color.

4. The method of making a messaging food product, the method as claimed in claim 1, wherein the specified time period is 5 minutes.

5. The method of making a messaging food product, the method as claimed in claim 1, wherein the primary message is predetermined content.

6. The method of making a messaging food product, the method as claimed in claim 1, wherein the at least one spoon message includes a secondary message, and wherein the secondary message is positioned within the second half portion.

7. The method of making a messaging food product, the method as claimed in claim 6, wherein the secondary message is either predetermined content or customized content.

8. The method of making a messaging food product, the method as claimed in claim 1, wherein at least one decoration is inscribed onto the first face, and wherein the at least one decoration is positioned peripheral to the at least one spoon message.

9. The method of making a messaging food product, the method as claimed in claim 8 comprises the steps of:
providing a laser etching device; and,
printing the at least one decoration onto the first face with the laser etching device before step (D).

10. The method of making a messaging food product, the method as claimed in claim 1, wherein the first face includes a central section and a margin section, and wherein the margin section is positioned around the central section, and wherein the at least one spoon message is positioned within the central section.
